(19) United States
(12) Patent Application Publication
(10) Pub. No.: US 2024/0393011 A1
(43) Pub. Date: Nov. 28, 2024

(54) HEATING ASSEMBLY AND LIQUID HEATER

(71) Applicant: BESTWAY INFLATABLES & MATERIAL CORP., Shanghai (CN)

(72) Inventor: Xianglin ZENG, Shanghai (CN)

(21) Appl. No.: 18/379,274

(22) Filed: Oct. 12, 2023

(30) Foreign Application Priority Data
May 22, 2023 (CN) 202321249010.X

(51) Int. Cl. F24H 1/12

(52) U.S. Cl. CPC F24H 1/121; F24H 2250/04

(57) ABSTRACT

A liquid heater is provided including a heating assembly including: a heat-conducting shell defining therein a receiving cavity extending in a length direction of the heat-conducting shell and including a first opening at a first end of the receiving cavity and a second opening at a second end of the receiving cavity; a first restraining element disposed at the first opening; a second restraining element disposed at the second opening; and a Positive Temperature Coefficient (PTC) heat-generating unit entirely disposed within the receiving cavity between the first restraining portion and the second restraining portion. The first restraining element prevents the PTC heat-generating unit from passing through the first end of the cavity, and the second restraining element prevents the PTC heat-generating unit from passing through the second end of the cavity.

### CROSS-REFERENCE TO RELATED APPLICATION

This Application claims priority from Chinese Application CN202321249010.X, filed May 22, 2023 in China, the disclosure of which is incorporated herein by reference in its entirety.

### BACKGROUND

### 1. Field

Example embodiments relate to of liquid heaters, and in particular to a heating assembly and a liquid heater.

### 2. Description of Related Art

Currently, Positive Temperature Coefficient (PTC) liquid heaters are widely used in household appliances, such as SPA pools, entertainment pools, water dispensers foot baths, and other products.

An existing PTC liquid heater may include a PTC heating assembly including a PTC heat-generating unit and a metal shell. The heat generated by the electrified PTC heat-generating unit is transferred to the metal shell, and then the metal shell heats the liquid flowing over its surface.

Referring to FIG. 1, which illustrates an example related art PTC heating assembly 1, in order to aid in heat conduction, a PTC heat-generating unit 11 and a metal shell 10 may be tightly pressed against each other. However, while the PTC heat-generating unit 11 and the metal shell 10 are tightly pressed against each other, the thermal expansion and contraction of the PTC heat-generating unit 11 is still inevitable. The PTC heat-generating unit 11 extends within the length of the metal shell 10 when heated, and retracts when cooled. Under the influence of various factors, such as the surface condition of a contact surface between the PTC heat-generating unit 11 and the metal shell 10, the expansion rates of different materials and process errors, the position of the PTC heat-generating unit 11 within the metal shell 10 may change unpredictably after the PTC heating assembly 1 is subjected to multiple heating-cooling cycles. Eventually, the PCT heat-generating unit 11 may move until it is partially outside of the metal shell 10, resulting in electrical leakage or failure of the PTC heat-generating unit.

### SUMMARY

Example embodiments may address at least the above problems and/or disadvantages and other disadvantages not described above. Also, example embodiments are not required to overcome the disadvantages described above, and may not overcome any of the problems described above.

One or more example embodiments may provide a heating assembly and a liquid heater which avoids the electrical leakage of the heating assembly or the failure of the PTC heat-generating unit.

According to an aspect of an example embodiment, a liquid heater is provided, comprising: a heating assembly comprising: a heat-conducting shell defining therein a receiving cavity extending in a length direction of the heat-conducting shell and comprising a first opening disposed at a first end of the receiving cavity and a second opening disposed at a second end of the receiving cavity; a first restraining element disposed at the first opening; a second restraining element disposed at the second opening; and a Positive Temperature Coefficient (PTC) heat-generating unit entirely disposed within the receiving cavity between the first restraining element and the second restraining element, wherein the first restraining portion prevents the PTC heat-generating unit from passing through the first end of the receiving cavity, and the second restraining element prevents the PTC heat-generating unit from passing through the second end of the receiving cavity.

A dimension of an inner perimeter of the first restraining portion may be smaller than a dimension of an outer perimeter of the PTC heat-generating unit, thereby preventing the PTC heat-generating unit from passing through the first end of the receiving cavity. The heating assembly may further comprise a wire electrically connected to the PTC heat-generating unit and extending out of the heat-conducting shell through the first end of the receiving cavity.

The dimension of the inner perimeter of the first restraining element may gradually decrease in a direction from a center of the receiving cavity to the first end of the receiving cavity.

The first restraining element and the heat-conducting shell may be a single, integral element.

The heating assembly may further comprise: an end cap at least partially disposed between the first opening and the PTC heat-generating unit, wherein the electric wire passes through an aperture in the first end cap, and wherein at least a part of the end cap abuts against an inner wall of the heat-conducting shell.

The first restraining element may comprise: a restraining member fixed to the first end of the heat-conducting shell; wherein the heating assembly further comprises a wire electrically connected to the PTC heat-generating unit and extending through an aperture in the restraining member.

The heating assembly may further comprise: an end cap at least partially disposed between the restraining member and the PTC heat-generating unit, wherein an aperture in the end cap is in communication with the aperture in the restraining member, and wherein the electric wire extends through the aperture in the end cap.

The heating assembly may further comprise: a grounding post; wherein the second restraining element comprises an electrically conductive member connected to the second end of the heat-conducting shell and to the grounding post.

The heating assembly may further comprise: an end cap disposed between the electrically conductive member and the PTC heat-generating unit, wherein at least a part of the end cap abuts against an inner wall of the heat-conducting shell.

The heating assembly may further comprise: a grounding post; wherein the heat-conducting shell comprises a first layer and a second layer electrically connected to the first layer, wherein the PTC heat-generating unit is in contact with an inner surface of the first layer; and; wherein the second restraining element portion comprises an electrically conductive member connected to the second layer of the PTC heat-generating unit and to the grounding post.

The liquid heater may further comprise a housing defining a chamber therein extending in the length direction of the heat-conducting shell, wherein at least part of the heating assembly is disposed within the chamber.

According to an aspect of another example embodiment, a liquid heater is provided comprising: a heating assembly comprising: a heat-conducting shell defining a receiving cavity therein; a Positive Temperature Coefficient (PTC) heat-generating unit disposed within the cavity; a first restraining element disposed at a first end of the heat-conducting shell, the first restraining element having an opening therein with an inner dimension smaller than an outer dimension of the PTC heat-generating unit; a second restraining element disposed at a second end of the heat-conducting shell, the second restraining element having an opening therein with an inner dimension smaller than the outer dimension of the PCT heat-generating unit.

The heat conducting shell, the first restraining element, and the second restraining element may be a single, integral element.

The heating assembly may further comprise: an electric conduit traversing the opening in one of the first restraining element and the second restraining element and electrically connected to the PTC heat-generating unit.

The heating assembly may further comprise: a grounding post; wherein the second restraining element comprises an electrically conductive member connected to the second end of the heat-conducting shell and to the grounding post.

The heat-conducting shell may comprise a first layer and a second layer electrically connected to the first layer; wherein the PTC heat-generating unit is in contact with an inner surface of the first layer.

The liquid heater may further comprise: a housing defining a chamber therein extending in the length direction of the heat-conducting shell, wherein at least part of the heating assembly is disposed within the chamber.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a cross-sectional view of a related-art heating assembly;

FIG. 2 is a perspective view of a heating assembly according to an example embodiment;

FIG. 3 is a cross-sectional view of a heating assembly according to an example embodiment;

FIG. 4 is an enlarged view of a first contracted part of a heating assembly; according to an example embodiment

FIG. 5 is a partial enlarged view of an electrically conductive member of a heating assembly according to an example embodiment;

FIG. 6 is a partial perspective view of a restraining member of a heating assembly according to an example embodiment;

FIG. 7 is a partial cross-sectional view of a restraining member of a heating assembly according to an example embodiment;

FIG. 8 is a perspective view of a liquid heater according to an example embodiment; and

FIG. 9 is a cross-sectional view of a liquid heater according to an example embodiment.

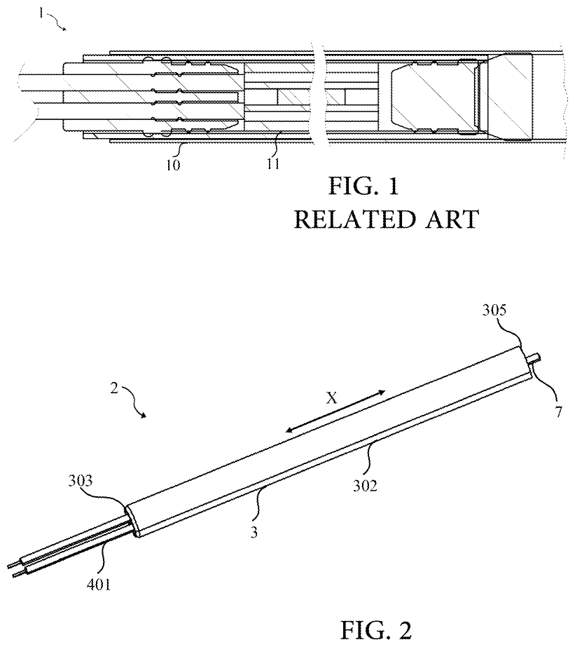

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including”, “comprise, and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described here in detail.

Herein, like reference signs and letters denote like items in the following drawings. Once an item is defined with respect to one of the drawings, it is not repeatedly defined or explained with respect to subsequent drawings.

As used herein, the orientation or position relationships indicated by the terms such as “upper,” “lower,” “inner,” and “bottom” are based on the orientation or position relationships shown in the drawings or the orientation or position relationships in which an example product is customarily placed during use, and are only intended to facilitate description, rather than indicating or implying that the apparatus or element indicated must have a specific orientation or be configured and operated in the specific orientation, and therefore cannot be construed as limiting.

As used herein, the terms “arrange,” “connected,” and “connection” should be understood in a broad sense, unless otherwise explicitly specified and limited. For example, a connection can be a fixed connection, a detachable connection, or an integral connection; or may be a mechanical connection or an electrical connection; and can be directly connected, or indirectly connected by means of an intermediate medium, or communication between interiors of two elements. For those of ordinary skill in the art, the specific meaning of the terms used herein should be understood in specific cases.

### Example Embodiment 1

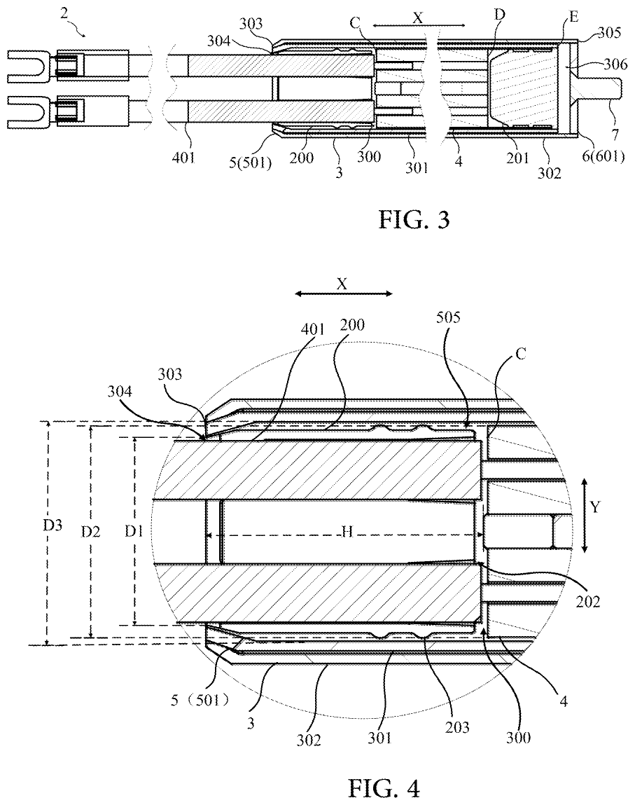

Referring to FIGS. 2 and 3, a heating assembly 2 according to the first example embodiment comprises: a heat-conducting shell 3, a PTC heat-generating unit 4, a first restraining portion 5, and a second restraining portion 6. The heat-conducting shell 3 is provided with a receiving cavity 300 extending in a length direction (indicated by an X in FIG. 3) of the heat-conducting shell 3, and the heat-conducting shell 3 is provided with a first opening 304 at its first end 303 and a second opening 306 at its second end 305. The first restraining portion 5 is provided at the first opening 304 to prevent the PTC heat-generating unit 4 from moving outside of the heat-conducting shell 3 through the first opening 304. The second restraining portion 6 is provide at the second opening 306 to prevent the PTC heat-generating unit 4 from moving outside the heat-conducting shell 3 through the second opening 306.

The entirety of the PTC heat-generating unit 4 is disposed within the receiving cavity 300. The heat-conducting shell 3 has good thermal conductivity to efficiently transfer the heat generated by the PTC heat-generating unit 4 to a liquid to be heated. According to an example aspect, the heat-conducting shell 3 also has good electrical conductivity, so as to provide grounding for the heating assembly 2 by means of the heat-conducting shell 3. Optionally, the heat-conducting shell 3 may be made of a metal such as, but not limited to, stainless steel, an aluminum alloy, and a titanium alloy. According to one or more example aspects, the heat-conducting shell 3 may be further placed within a protective shell (not shown), which has good thermal conductivity and corrosion resistance and is in good contact with the heat-conducting shell 3. In other words, the heat-conducting shell 3 may be in direct or indirect contact with the liquid to be heated.

With the provision of the first restraining portion 5 and the second restraining portion 6, the PTC heat-generating unit 4 may move relative to the heat-conducting shell 3 in the length direction (indicated by X in FIG. 3), for example when subjected to multiple heating-cooling cycles, but its movement is limited to the range between the first restraining portion 5 and the second restraining portion 6. That is, the first restraining portion 5 and the second restraining portion 6 respectively restrain the PTC heat-generating unit 4 at the first end 303 and the second end 305 in the length direction of the heat-conducting shell 3, thereby preventing the PTC heat-generating unit 4 from slipping out of the heat-conducting shell 3 through the first opening 304 and/or the second opening 306, and further avoiding the occurrence of problems such as electrical leakage or failure of the PTC heat-generating unit 4.

Referring to FIGS. 3 and 4, optionally, the first restraining portion 5 may comprise a first contracted part 501. The first contracted part 501 is formed at the first end 303 of the heat-conducting shell 3, the first opening 304 is provided at the first contracted part 501, and a dimension D1 of the first opening 304 is smaller than an outer contour dimension D2 of the PTC heat-generating unit 4, so that the first contracted part 501 forms the first restraining portion 5 at the first end 303. The heating assembly 2 further comprises an electric wire 401. The electric wire 401 is electrically connected to the PTC heat-generating unit 4 and extends out of the heat-conducting shell 3 through the first opening 304.

The first contracted part 501 may be formed by narrowing the first end 303 of the heat-conducting shell 3, so that the radial dimension DI of the first opening 304 of the first end 303 of the heat-conducting shell 3 is smaller than the outer contour dimension D2 of the PTC heat-generating unit 4, thereby preventing the PTC heat-generating unit 4 from slipping out of the first opening 304 of the first end 303 of the heat-conducting shell 3.

An inner contour dimension of the first contracted part 501 may gradually decreases toward the first opening 304. For example, an inner surface of the first contracted part 501 may be substantially conical, so that the farther the PTC heat-generating unit 4 moves toward the first opening 304, the greater the resistance it receives.

In the length direction (indicated by X in FIG. 4) of the heat-conducting shell 3, the dimension (i.e. the minimum radial dimension of the first contracted part 501) of the portion of the first contracted part 501 which is outside the receiving cavity is defined as the radial dimension D1 of the first opening 304. The radial dimension (i.e. the maximum radial dimension of the first contracted part 501) of the other end of the first contracted part 501 located in the receiving cavity 300, is defined as D3. D3 is greater than the outer dimension, defined as D2, of the PTC heat-generating unit 4. In a direction in which the electric wire 401 extends out, the radial dimension of the first contracted part 501 gradually decreases from the maximum radial dimension D3 of a circular metal pipe (the heat-conducting shell 3) to the minimum radial dimension D1. In this case, the radial dimension D1 of the first contracted part 501 at the first opening 304 may be smaller than the outer contour dimension D2 of the PTC heat-generating unit 4, so that the PTC heat-generating unit 4 is restrained by the first contracted part 501, and the PTC heat-generating unit 4 is thus prevented from slipping out of the heat-conducting shell 3 in the direction in which the electric wire 401 extends out.

Optionally, the heat-conducting shell 3 may be made from a metal pipe, and the first contracted part 501 may be formed by pressing at least a part of the first end 303 of the heat-conducting shell 3. More specifically, the first contracted part 501 for restraining the movement of the PTC heat-generating unit 4 may be formed by pressing an end of the heat-conducting shell 3, so that the first restraining portion 5 is formed, and the production efficiency and the product reliability may be high. In a case in which the heat-conducting shell 3 is made from a circular metal pipe and the first contracted part 501 is formed by pressing the whole periphery of the first end 303 of the heat-conducting shell 3, the middle part and the first opening 304 of the heat-conducting shell 3 may each have a circular or approximately circular cross-sectional profile.

Referring to FIGS. 3 and 4, the first contracted part 501 and the heat-conducting shell 3 begin as a tubular integral structure having an inner diameter D3, and the first contracted part 501 is formed by pressing and bending an end of the first end 303 of the heat-conducting shell 3. It can be understood that, alternately, the heat-conducting shell 3 may have non-circular cross-sectional profile (for example, but not limited to, elliptical, square or rectangular). It can also be understood that, alternately, the first contracted part 501 may be formed by pressing only one or several places (instead of the whole outer periphery) of the end of the heat-conducting shell 3.

Optionally, the first restraining portion 5 may be configured in other ways. For example, another component (such as a metal sheet or a metal block) may be fixed to the first end 303 of the heat-conducting shell 3 by welding or by another means, so that the first restraining portion 5 for preventing the PTC heat-generating unit 4 from slipping out of the heat-conducting shell 3 is formed at the first end 303 of the heat-conducting shell 3. By adding a component to form the first restraining portion 5, the internal stress and tiny cracks caused by pressing and deforming the heat-conducting shell 3 can be avoided, the corrosion of the heat-conducting shell 3 by the external environment can be reduced, and the service life of the heat-conducting shell 3 can be prolonged.

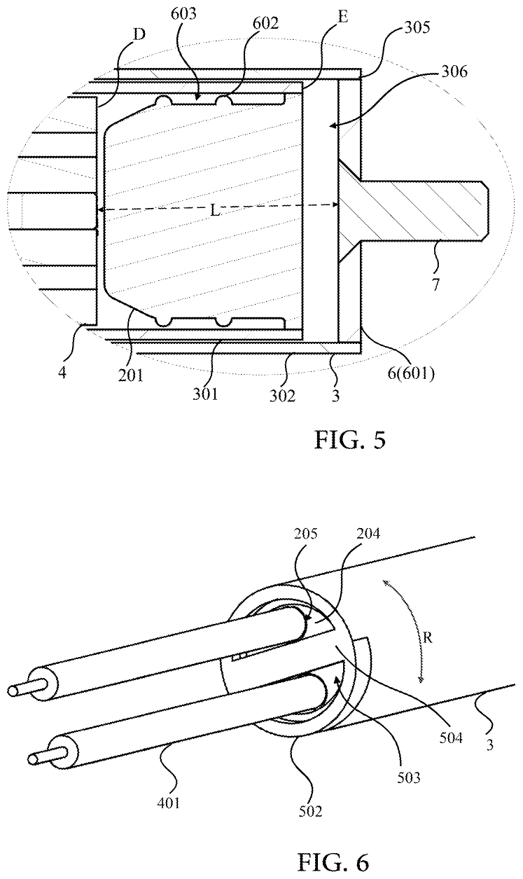

Referring to FIGS. 3 and 5, optionally, the second restraining portion 6 may comprise an electrically conductive member 601. The electrically conductive member 601 may be fixedly connected to the second end 305 of the heat-conducting shell 3. Illustratively, the electrically conductive member 601 is of a plate-like structure, which has a shape matching the cross-sectional shape of the heat-conducting shell 3. For example, the heat-conducting shell 3 has a circular inner cross-sectional contour, and the electrically conductive member 601 is a circular metal plate.

Optionally, an outer peripheral surface of the electrically conductive member 601 may be circumferentially welded to an inner wall of the heat-conducting shell 3 near the second end 305, so that the electrically conductive member 601 is fixed to the heat-conducting shell 3, and the PTC heat-generating unit 4 is thus prevented from slipping out of the heat-conducting shell 3 in the length direction of the heat-conducting shell 3 and toward the second restraining portion 6.

Optionally, the heating assembly 2 may further comprise a grounding post 7. The grounding post 7 may be connected to an electrically conductive member which is connected to the heat-conducting shell 3. For example, the electrically conductive member is the electrically conductive member 601 described above. The grounding post 7 may be fixedly connected to an outer end face of the electrically conductive member 601. Illustratively, the grounding post 7 is fixedly connected to the electrically conductive member 601 by riveting. The grounding post 7 extends outward and is grounded. Compared with a solution of grounding the heating assembly by connecting the heating assembly and a grounded metal flange together, this solution may significantly reduce costs and ensure reliable grounding. It can be understood that, alternately, the grounding post 7 may be mechanically connected to the electrically conductive member 601 in any of a number of other ways. For example, the grounding post 7 may be connected to the electrically conductive member 601 by screwing or welding.

After the PTC heat-generating unit 4 is placed inside the heat-conducting shell 3, the heat-conducting shell 3 may be made to come into close contact with the PTC heat-generating unit 4 by pressing the heat-conducting shell 3 to ensure the heat conduction efficiency. Such pressing, however, may form a number of tiny cracks on an outer surface of the heat-conducting shell 3. In this case, if the outer surface of the heat-conducting shell 3 comes into contact with the liquid to be heated, the heat-conducting shell 3 may be corroded quickly.

In order to delay or eliminate this potential corrosion, optionally, referring to FIGS. 3 to 5, the heat-conducting shell 3 may comprise a first layer 301 and a second layer 302, that is, the heat-conducting shell 3 may have a double-layer shell structure. Illustratively, the outer periphery of the electrically conductive member 601 is welded to an inner wall of the second layer 302. The PTC heat-generating unit 4 is in contact with an inner surface of the first layer 301, and an outer surface of the first layer 301 is connected to an inner surface of the second layer 302. Heat-conducting gel is applied between the PTC heat-generating unit 4 and the first layer 301 and between the first layer 301 and the second layer 302.

Optionally, heat-conducting gel may be applied on the inner surface of the first layer 301 of the heat-conducting shell 3, and after the PTC heat-generating unit 4 is inserted into the first layer 301, the PTC heat-generating unit 4 may be closely attached to the first layer 301 by pressing the first layer 301, so that the relative movement between the PTC heat-generating unit 4 and the first layer 301 is reduced, and the heat conduction efficiency between the PTC heat-generating unit 4 and the first layer 301 is provided. Then, the first layer 301 is inserted into the second layer 302, and a gap between the first layer 301 and the second layer 302 is filled with the heat-conducting gel to improve heat conduction.

This arrangement of inserting the first layer 301 into the second layer 302 may limit the creation of tiny cracks formed on the outer surface of the first layer 301 after the PTC heat-generating unit 4 and the first layer 301 are pressed from being exposed to the heated liquid (e.g., water). Moreover, an outer surface of the non-pressed second layer 302 may be smoother than the outer surface of the pressed first layer 301, so that the second layer 302 may be relatively less susceptible to corrosion when directly exposed to the heated liquid than the first layer 301. In this way, the heat-conducting shell 3 may be less likely to be corroded by the heated liquid after being exposed to the liquid, so that a safer heat-conducting shell 3 is achieved. Illustratively, the first layer 301 is an aluminum pipe to improve the heat transfer efficiency of the heat-conducting shell 3, and the second layer 302 is a titanium pipe to improve the corrosion resistance of the heat-conducting shell 3.

In a case in which the heat-conducting shell 3 comprises a first layer 301 and a second layer 302, the optional grounding post 7 may be directly or indirectly connected to the first layer 301. For example, the grounding post 7 may be directly connected to the first layer 301 by being welded to an end of the first layer 301, or the grounding post 7 may be indirectly connected to the first layer 301 via the second layer 302 by being welded to an end of the second layer 302.

Referring to FIGS. 3 and 4, the heating assembly 2 may further comprise a first end cap 200. At least a part of the first end cap 200 may be arranged between the first opening 304 and the PTC heat-generating unit 4 in the length direction (indicated by the X in FIG. 3) of the heat-conducting shell 3. The first end cap 200 is provided with a first aperture 202 for the electric wire 401 to extend out from the first aperture 202. A side face of the first end cap 200 partially or entirely abuts against the inner surface of the first layer 301 of the heat-conducting shell 3 in a radial direction of the first end cap 200.

Illustratively, a spacing distance H is provided between the part of the first contracted part 501, located at the first opening 304, and an end C of the first contracted part, near the PTC heat-generating unit 4, so that the first end cap 200 is received in this spacing distance H.

Illustratively, a part of the first end cap 200 may be disposed in the heat-conducting shell 3, and another part may be located at the first contracted part 501. The outer periphery of the first end cap 200 may be provided with a first protrusion 203. The first protrusion 203 can abut against the inner surface of the first layer 301 of the heat-conducting shell 3 to form a first sealed area 505, thereby limiting a flow of the heat-conducting gel between the first and second layers 301 and 302 of the heat-conducting shell 3 into the PTC heat-generating unit 4 to potentially cause failure of the PTC heat-generating unit 4.

Optionally, the first end cap 200 may be a rubber stopper. It can be understood that, alternately, the first end cap 200 may be made of any of a number of other materials (for example, but not limited to, metal, such as stainless steel or an aluminum alloy; silicone; or polyvinyl chloride (PVC)).

Illustratively, the first end cap 200 may be provided with two first apertures 202 respectively for two electric wires 401 to extend out.

Referring to FIGS. 3 and 5, the heating assembly 2 may further comprise a third end cap 201. The third end cap 201 may be arranged between the electrically conductive member 601 and the PTC heat-generating unit 4, and a side face of the third end cap 201 may partially or entirely abut against the inner surface of the first layer 301 of the heat-conducting shell 3. Optionally, the third end cap 201 may be a rubber stopper. It can be understood that, alternately, the third end cap 201 may be made of any of a number of other materials (for example, but not limited to, metal, such as stainless steel or an aluminum alloy; silicone; or PVC).

Optionally, a spacing distance L may be provided between the electrically conductive member 601 and an end D of the PTC heat-generating unit 4, close to electrically conductive member 601, so as to receive the third end cap 201 in this spacing distance L. An end face of the third end cap 201, close the electrically conductive member 601, may be flush with an end E of the first layer 301 of the heat-conducting shell 3 in the radial direction. An outer periphery of the third end cap 201 may be provided with a second protrusion 602. The second protrusion 602 can abut against the inner surface of the first layer 301 of the heat-conducting shell 3 in the radial direction of the third end cap 201 to form a second sealed area 603.

The pressing of the first layer 301 and the second layer 302 of the heat-conducting shell 3 makes it possible for the heat-conducting gel disposed between them to respectively flow out toward the first end 303 and the second end 305 of the first layer 301. The second sealed area 603 of the third end cap 201 near the second end 305 of the heat-conducting shell 3 blocks the heat-conducting gel flowing out between the end E of the first layer 301 and the second layer 302, thereby limiting a flow of the heat-conducting gel into the PTC heat-generating unit 4 to potentially cause failure of the PTC heat-generating unit 4.

It can be understood that the heat-conducting shell 3 may alternately be a single-layer structure: for example, the first layer 301 may be provided while the second layer 302 is omitted, and the first and second restraining portions 5 and 6 may be provided, respectively, at the first end 303 and the second end 305 of the first layer 301, so as to restrain the PTC heat-generating unit 4 to prevent the same from slipping out of the heat-conducting shell 3. That is, a single-layer heat-conducting shell may also be applicable to this solution, and can achieve the same effect in solving the problem of the PTC heat-generating unit 4 extending out of the heat-conducting shell 3.

### Example Embodiment 2

A heating assembly according to this example embodiment is substantially the same as that of Example Embodiment 1. The difference between this example embodiment and Example Embodiment 1 lies in that the specific structure of the first restraining portion is changed. Specifically, in this example embodiment, a restraining member is used as the first restraining portion to replace the first contracted part in Example Embodiment 1.

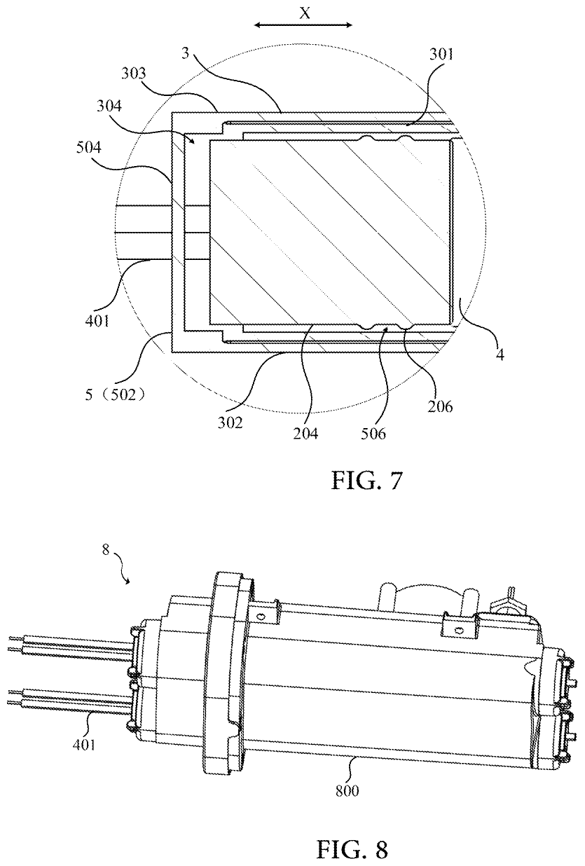

Specifically, referring to FIGS. 6 and 7, the first restraining portion 5 is a restraining member 502, and the restraining member 502 is fixed to the first opening 304 of the first end 303 of the heat-conducting shell 3. Illustratively, the restraining member 502 may be connected to the first opening 304, and the restraining member 502 may comprise a second aperture 503. The heating assembly further comprises an electric wire 401 electrically connected to the PTC heat-generating unit 4 and extending out from the second aperture 503. Illustratively, the restraining member 502 may comprise two second apertures 503 respectively for two electric wires 401 to extend out.

Optionally, the restraining member 502 may be fixedly connected to the first end 303 of the heat-conducting shell 3 in the circumferential direction (indicated by R in FIG. 6), and a connecting portion 504 of the restraining member 502 restrains the PTC heat-generating unit 4 in the length direction (indicated by X in FIG. 7) of the heat-conducting shell 3 to prevent the PTC heat-generating unit 4 from slipping out of the heat-conducting shell 3 in the direction in which the electric wire 401 extends out.

Optionally, the heating assembly may further comprise a second end cap 204. The second end cap 204 may be arranged between the restraining member 502 and the PTC heat-generating unit 4. The second end cap 204 may be provided with a third aperture 205. The third aperture 205 is in communication with the second aperture 503, and the electric wire 401 passes through the third aperture 205. Illustratively, the electric wire 401 may first pass through the third aperture 205 of the second end cap 204, and then pass through the second aperture 503 of the restraining member 502, so as to be connected to an external power supply.

Optionally, an outer periphery of the second end cap 204 may be provided with a third protrusion 206. The third protrusion 206 can abut against the inner surface of the first layer 301 of the heat-conducting shell 3 to form a third sealed area 506, thereby limiting a flow of the heat-conducting gel from between the first layer 301 and the second layer 302 of the heat-conducting shell 3 into the PTC heat-generating unit 4 to potentially cause failure of the PTC heat-generating unit 4.

Optionally, the second end cap 204 may be the same as or similar to the first end cap 200 in the above example embodiment, and both of which are rubber stoppers. It can be understood that, alternately, the second end cap 204 may be made of any of a number of other materials (for example, but not limited to, metal, such as stainless steel or an aluminum alloy; silicone; or PVC).

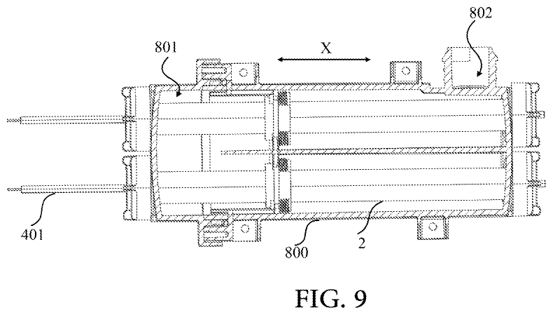

Referring to FIGS. 8 and 9, the heating assembly 2 described with respect to the above example embodiments can be used in an example liquid heater 8. The liquid heater 8 may comprise a housing 800 and any one of the heating assemblies 2 described above. The housing 800 may be internally provided with a chamber 801, and the liquid (e.g., water) to be heated may flow through the chamber 801 and be heated by the heating assembly 2. For example, the chamber 801 may extend in the length direction of the heat-conducting shell 3 of the heating assembly 2, and the heating assembly 2 may partially or entirely penetrate the chamber 801.

Optionally, the housing 800 of the liquid heater 8 may comprise a pipeline 802 for the fluid to flow into and out from the chamber 801, and the heating assembly 2 may be placed in the chamber 801. Liquid enters the chamber 801 through the pipeline 802, and then directly or indirectly contacts the outer surface of the heat-conducting shell 3 of the heating assembly 2, so that the liquid flowing over the surface of the heat-conducting shell 3 is heated by the electrified PTC heat-generating unit 4 via the heat-conducting shell 3.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A liquid heater, comprising:
a heating assembly comprising:
a heat-conducting shell defining therein a receiving cavity extending in a length direction of the heat-conducting shell and comprising a first opening disposed at a first end of the receiving cavity and a second opening disposed at a second end of the receiving cavity;
a first restraining element disposed at the first opening;
a second restraining element disposed at the second opening; and
a Positive Temperature Coefficient (PTC) heat-generating unit entirely disposed within the receiving cavity between the first restraining element and the second restraining element, wherein the first restraining portion prevents the PTC heat-generating unit from passing through the first end of the receiving cavity, and the second restraining element prevents the PTC heat-generating unit from passing through the second end of the receiving cavity.

2. The liquid heater of claim 1,
wherein a dimension of an inner perimeter of the first restraining portion is smaller than a dimension of an outer perimeter of the PTC heat-generating unit, thereby preventing the PTC heat-generating unit from passing through the first end of the receiving cavity;
wherein the heating assembly further comprises a wire electrically connected to the PTC heat-generating unit and extending out of the heat-conducting shell through the first end of the receiving cavity.

3. The liquid heater of claim 2, wherein the dimension of the inner perimeter of the first restraining element gradually decreases in a direction from a center of the receiving cavity to the first end of the receiving cavity.

4. The liquid heater of claim 2, wherein the first restraining element and the heat-conducting shell are a single, integral element.

5. The liquid heater of claim 2, wherein the heating assembly further comprises:
an end cap at least partially disposed between the first opening and the PTC heat-generating unit, wherein the electric wire passes through an aperture in the end cap, and wherein at least a part of the end cap abuts against an inner wall of the heat-conducting shell.

6. The liquid heater of claim 1, wherein the first restraining element comprises:
a restraining member fixed to the first end of the heat-conducting shell;
wherein the heating assembly further comprises a wire electrically connected to the PTC heat-generating unit and extending through an aperture in the restraining member.

7. The liquid heater of claim 6, wherein the heating assembly further comprises:
an end cap at least partially disposed between the restraining member and the PTC heat-generating unit, wherein an aperture in the end cap is in communication with the aperture in the restraining member, and wherein the electric wire extends through the aperture in the end cap.

8. The liquid heater of claim 1, wherein the heating assembly further comprises:
a grounding post;
wherein the second restraining element comprises an electrically conductive member connected to the second end of the heat-conducting shell and to the grounding post.

9. The liquid heater of claim 8, wherein the heating assembly further comprises:
an end cap disposed between the electrically conductive member and the PTC heat-generating unit, wherein at least a part of the end cap abuts against an inner wall of the heat-conducting shell.

10. The liquid heater of claim 1, wherein the heating assembly further comprises:
a grounding post;
wherein the heat-conducting shell comprises a first layer and a second layer electrically connected to the first layer,
wherein the PTC heat-generating unit is in contact with an inner surface of the first layer; and;
wherein the second restraining element portion comprises an electrically conductive member connected to the second layer of the PTC heat-generating unit and to the grounding post.

11. The liquid heater of claim 1, further comprising a housing defining a chamber therein extending in the length direction of the heat-conducting shell, wherein at least part of the heating assembly is disposed within the chamber.

12. A liquid heater comprising:
a heating assembly comprising:
a heat-conducting shell defining a receiving cavity therein;
a Positive Temperature Coefficient (PTC) heat-generating unit disposed within the cavity;
a first restraining element disposed at a first end of the heat-conducting shell, the first restraining element having an opening therein with an inner dimension smaller than an outer dimension of the PTC heat-generating unit;
a second restraining element disposed at a second end of the heat-conducting shell, the second restraining element having an opening therein with an inner dimension smaller than the outer dimension of the PCT heat-generating unit.

13. The liquid heater of claim 12,
wherein the heat conducting shell, the first restraining element, and the second restraining element are a single, integral element.

14. The liquid heater of claim 12, wherein the heating assembly further comprises:
an electric conduit traversing the opening in one of the first restraining element and the second restraining element and electrically connected to the PTC heat-generating unit.

15. The liquid heater of claim 12, wherein the heating assembly further comprises:
a grounding post;
wherein the second restraining element comprises an electrically conductive member connected to the second end of the heat-conducting shell and to the grounding post.

16. The liquid heater of claim 12,
wherein the heat-conducting shell comprises a first layer and a second layer electrically connected to the first layer;
wherein the PTC heat-generating unit is in contact with an inner surface of the first layer.

17. The liquid heater of claim 12, further comprising:
a housing defining a chamber therein extending in the length direction of the heat-conducting shell, wherein at least part of the heating assembly is disposed within the chamber.
